(19) United States
(12) Patent Application Publication
(10) Pub. No.: US 2005/0078836 A1
(43) Pub. Date: Apr. 14, 2005

(54) Instantaneous on-line acoustic apparatus capable of sharing enjoying and recording music

(76) Inventor: Jack Ou, Shijr City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/747,364

(22) Filed: Dec. 30, 2003

(30) Foreign Application Priority Data
Oct. 8, 2003 (TW) 092127902

(51) Int. Cl. H04B 3/00; H04R 25/00

(52) U.S. Cl. 381/77; 381/374

(57) ABSTRACT

The present invention provides an instantaneous on-line acoustic apparatus capable of recording contents of conversation and music, and sharing the music or content of recorded music with against party during communication. Moreover, it is able to mingle the music or surrounding noise, either presently existing or pre-recorded, into the phone line, so as to purposedly camouflage the user's location at the very moment communication takes place. The apparatus is simply constructed, inexpensive, and of good portability.

### BACKGROUND OF THE INVENTION

1. Field of the Invention

The present invention relates to an instantaneous on-time acoustic apparatus capable of shoring enjoying and recording music, and more particularly to an acoustic electronic apparatus capable of recording contents of conversation and music, and sharing the music or the content of recorded music to against party during communication.

2. Description of the Prior Art

During the time the user is enjoying the music or other broadcast on a portable radio, MP3 or the like, the sound volume is amplified as large as possible so as to overcome the surrounding noise to an extent the user himself/herself misses the ringing of the mobile phone by failing to take off the earphones on time. For eliminating such a shortcoming, a device with an extintion connector from the terminals of the earphones to the mobile phone and the portable music broadcaster has been on the market which enables the user to receive a phone call directly from coorparative earphones without taking them off duing listening to the music. In such cornbinated earphones of a mobile phone and a music broadcaster, an operation and control box is provided in which a sound volume and a microphone are provided for adjusting the sound intensity of the mobile phone and the protable music broadcaster. Moreover, for eliminating interference coming from the music during the mobile phone is on-line, a change over means is provided between the mobile phone and the music broadcaster.

In the acoustic electronic apparatus described above, neither the presently playing music or pre-recorded sounds (for example, the background sounds related to the privacy of the communication) can be transmitted to the other side over the mobile phone for reference, nor the content of the conversation be recorded unless an extra mobile phone recorder is added which is too sophisticated to use and carry with. The commercial mobile phone with an optional recorder is not only expensive considering its durable recording time, but also difficult to handle for an ordinary user. Therefore, improvement for the aforesaid conventional apparatus is absolutely necessary.

It is what the reason the inventor has put forth every effort for years by continuous research and experimentation attempting to find out the remedies to palliate the inherent shortcomings of the conventional techniques described above, and at last has succeeded in realizing the present invention.

### SUMMARY OF THE INVENTION

It is a first object of the present invention to provide an instantaneous on-line acoustic apparatus capable of recording contents of conversation and music, and sharing the music or content of recorded music with against party during communication.

It is a second object of the present invention to provide an instantaneous on-line acoustic apparatus mentioned above which can be purchased with a cheap price, yet the recording time can be prolonged and handled and operative easily by ordinary user.

It is a third object of the present invention to provide an instantaneous on-line acoustic apparatus described above which is easy for carrying and assembling by simplified construction.

It is a forth object of the present invention to provide an instantaneous on-line acoustic apparatus described above capable of mingling the music or surrounding noise, either presently exiting, or pre-recorded, in the phone lime so as to purposedly camouflage the user's real location at the very moment he/she is communicating with the against party over telephone.

To achieve these and other objects described above, the apparatus of the present invention comprises:
a control box which further including one or more than one earphone contactor or standard earphone jack, a stereo sound output press button lock witch, a microphone, a multi-sounds volume switch, and a mobile phone press button switch;
a standard female receptacle for dual sound output further including a female receptacle for mobile phone recorder, and a standard female receptacle for stereo sound recording and music sharing;
a mobile phone male plug;
a standard stero sound male plug; wherein
one end of the control box is connected with the standard female receptacle for dual sound output which further extends the mobile phone male plug and the standard stereo sound male plug.

### BRIEF DESCRIPTION OF THE DRAWINGS

The drawings disclose illustrative embodiments of the present invention which serve to exemplify the various advantages and objects hereof, and are as follows:

FIG. 1 is a schematic view of the present invention;

FIG. 2 is a block diagram of the present invention;

FIG. 3 is a schematic view in another embodiment of the present invention;

FIG. 4 is a schematic view showing the state that the press button lock switch for stereo sound output is closed upwardly for interrupting sound output;

FIG. 5 is a schematic view showing the state that the press button lock switch for stereo sound output is locked downwardly for outputting sound;

FIG. 6 is a schematic view in a further embodiment of the present invention;

### DETAILED DESCRIPTION OF THE PREFERRED EMBODIMENT

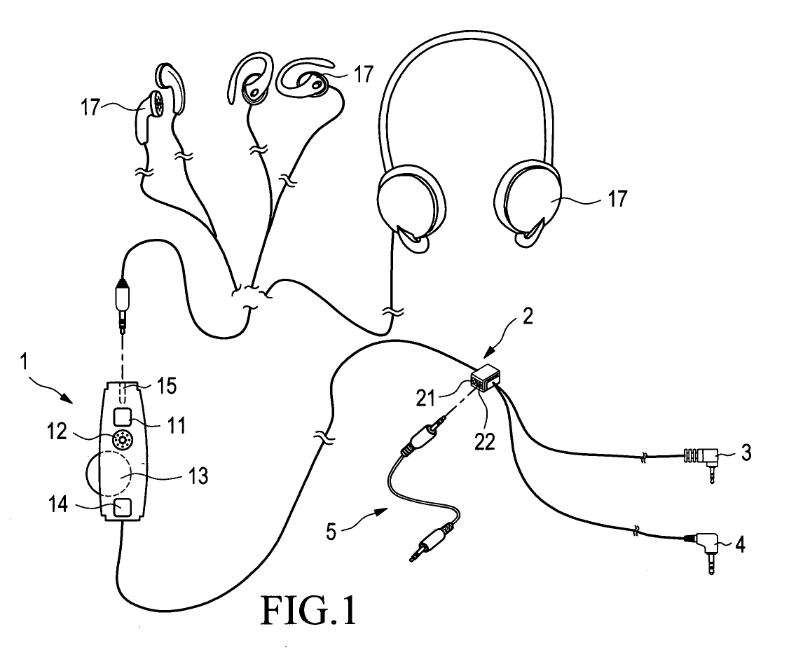

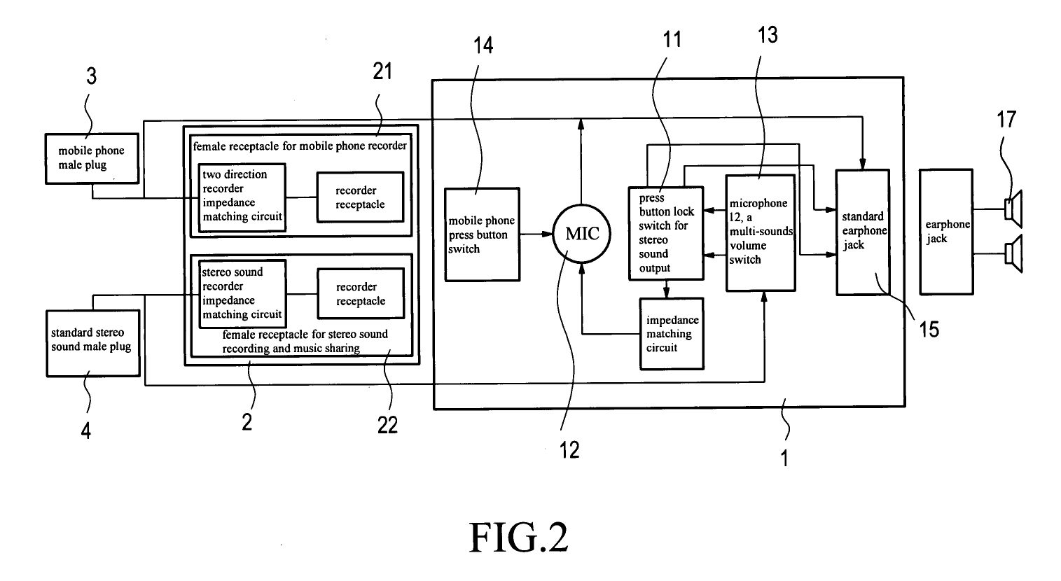

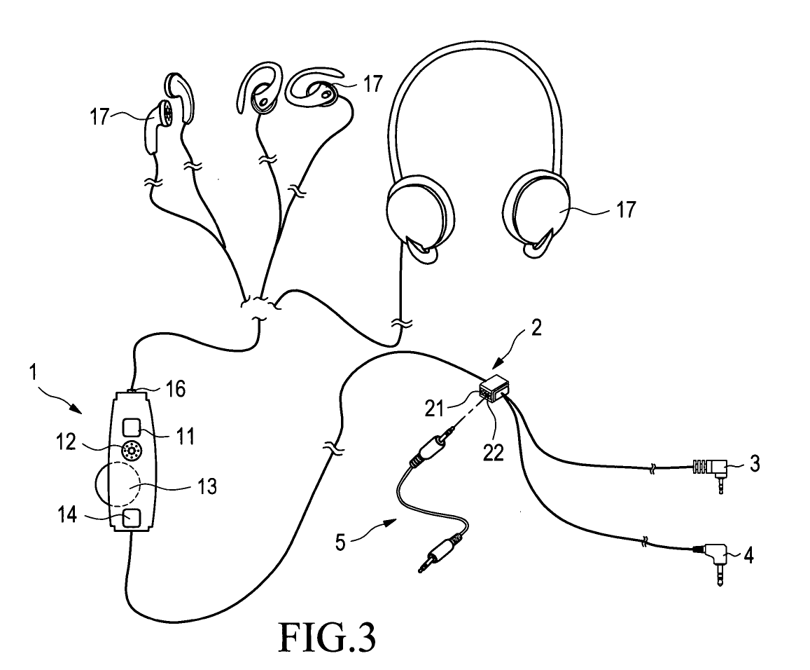

Referring to FIG. 1 through FIG. 3, the instantaneous on-line apparatus according to the present invention comprises a control box 1, a standard female receptacle for dual sound output 2, a mobile phone male plug 3, and a standard stereo sound male plug 4.

The control box 1 further includes one or more than one earphone contactor 16 or standard earphone jack 15, a press button lock switch for stereo sound output 11, a microphone 12, a multi-sounds volume switch 13, a mobile phone press button switch 14, and one end of the control box 1 is connected with the standard female receptacle for dual sound output 2.

The standard female receptacle 2 is provided with a female receptacle for mobile phone recorder 21 and a female receptacle for stereo sound recording and music sharing 22.

The mobile phone male plug 3 can be mated with various mobile phone earphone receptacles.

The standard stereo sound male plug 4 is capable of connecting with output receptacles of various portable broadcasters such as portable radios or MP3.

The earphone contactor 16 or the earphone jack 15 is fittable with various earphones 17 such as plug-in type, hanging type or cap type. The mobile phone male plug 3 and the stereo sound male plug 4 are respectively extended from the female receptacle 2. Besides, the female receptacles 21 and 22 can be respectively provided on the female receptacle 2.

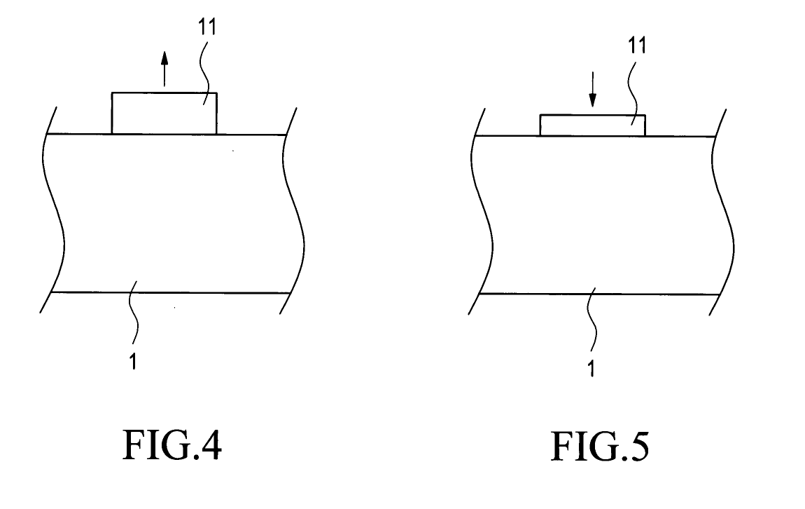

Referring to FIG. 4 and FIG. 5, when the press button lock 11 for stereo sound output 11 is pressed down, it shows two different states, the one is locked downwardly to output sound (FIG. 5); the other is closed upwardly to interrupt sound output, and the two states appear alternatively. That is to say, the downward locked state for outputting and the upward closed state for interrupting output will appear alternatively by sequentially pressing the lock switch 11.

Referring FIG. 1 through FIG. 5. In using the apparatus of the present invention, during the time when the user is listening to the music or other form of broadcaster from a portable broadcaster from the earphone 17, an incoming phone call to the mobile phone can be received by pressing down the press button lock switch 11 to make it in upward closed state for interrupting the output first, and then press the mobile phone press button switch 14 to receive the incoming phone call with the earphone 17 so as to communicated with against party thereby avoiding the against party being annoyed by the sound from the portable broadcaster of the user's side. In case the mobile phone is functionable for automatic receiving, the aforesaid change over operation can be omitted. If the against party likes to share enjoying the music from the user's side the music sound is able to transmit to the against party via the mobile phone by pressing down the lock switch 11 causing it to be in locked downwardly state for outputting the sound. Meanwhile, an extra earphone 17 can be plugged into the female receptacle 22 to allow the third party to share enjoying the stereo music playing in the portable broadcaster.

Referring again to FIGS. 1, 2 and 4, in the acoustic apparatus of the present invention, the female receptacle for mobile phone 21 provided to the standard female receptacle for dual sound output 2 can be connected to a recorder with the connecting wire for commercial standard stereo dual plug 5 available on the market, in the mobile phone into the recorder. Besides, the music playing in the portable broadcaster can also be recorded into the recorder by connecting the female receptacle for stereo sound recording and music sharing 22 to the recorder with the connecting wire 5 and then energizes the recorder. Moreover, in the acoustic apparatus of the present invention, the back ground sound such as noise in the railroad station or the like or indoor noise in a certain business office can be recorded with a recorder in advance and playing it in the on-line mobile phone by pressing the lock switch 11 downwardly for output so as to camouflage the location of the user thereby protecting the user's privacy and security.

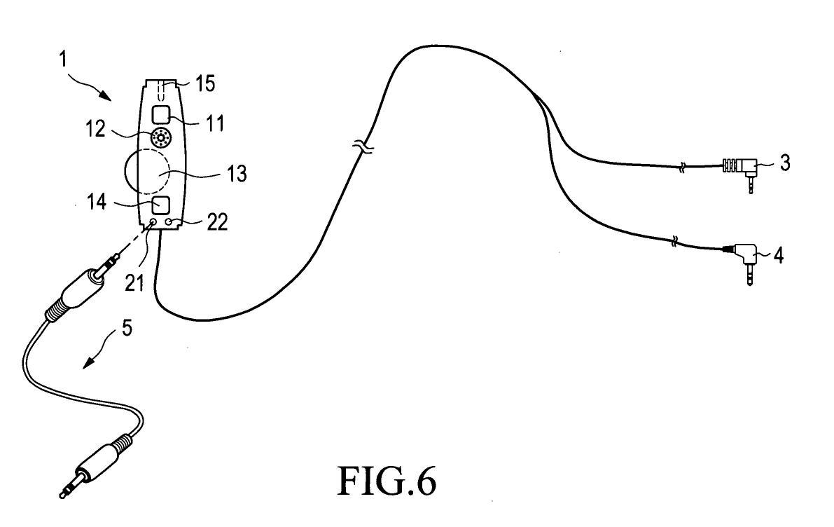

Referring to FIG. 6 together with FIG. 1, in the acoustic apparatus of the present invention, the female receptacle for mobile phone recorder 21 or the standard female receptacle for stereo sound recording and music sharing 22 may be directly equipped on the control box 1 or both instead of installing the female receptacle for dual sound output 2. Besides, the female receptacle for mobile phone recorder 21 or the standard female receptacle for stereo sound recording and music sharing 22 may be equipped alone on the female receptacle for dual sound output 2. Moreover, the aforesaid two female receptacles 21 and 22 mounted on the female receptacle for dual sound output 2 may be removed and installed on the control box 1, Alternatively, in the acoustic apparatus of the present invention, the mobile phone male plug 3 may be directly connected to a mobile phone having a built-in MP3 without installing the standard stereo sound male plug 4.

In all, the instantaneous on-line acoustic apparatus capable of sharing listening to /recording music according to the present invention has several noteworthy advantages compared with the resembling acoustic apparatus produced according to the conventional techniques, namely:

1. That by pressing the press button lock switch for stereo sound output upwardly in output state, and initiating the mobile phone, the user may enjoy the music while making a phone communication.

2. That during making phone call, the against party is able to share enjoying the music with the user if he/she presses the press button lock switch downwardly in output state.

3. That the content of conversation over the mobile phone can be recorded by energizing the recorder in case the recorder is connected to the female receptacle for mobile phone recorder using the connecting wire for commercial standard stereo dual plug available on the market.

4. The music the user is just enjoying may be recorded into a recorder by connecting the standard female receptacle for stereo sound recording and music sharing to the recorder using the connecting wire for commercial standard stereo dual plug and then press the recorder push button switch.

5. The background noise can be recorded into a recorder in advance and plays it in the on-line mobile phone so as to camouflage the actual location of the user for protecting the user's privacy and security.

6. The control box includes more than one earphone contactors or standard earphone jacks which serve for the particular user to enjoy the music using his/her own preferable earphone to mate with.

Many changes and modifications in the above described embodiments of the invention can, of course, be carried out without departing from the scope thereof. Accordingly, to promote the progress in science and the useful arts, the invention is disclosed and is intended to be limited only by the scope of the appended claims.

1 An instantaneous on-line acoustic apparatus capable of sharing enjoying and recording music comprising:
a control box including one or more than one earphone contactor or standard earphone jack, a press button lock switch for stereo sound output, a microphone, a multi-sound volume switch, and a mobile phone press button switch, and one end of said control box being connected with a standard female receptacle for dual sound output; and
said standard female receptacle for dual sound output being provided with a female receptacle for mobile phone recorder and a female receptacle for stereo sound recording and music sharing, wherein a mobile phone male plug and a standard stereo sound male plug are mated with said standard female receptacle for dual sound output.

2. The acoustic apparatus of claim 1, wherein said mobile phone male plug and said standard stereo sound male plug are directly mated with said control box without installing said standard female receptacle for dual sound output.

3. The acoustic apparatus of claim 2, wherein either said female receptacle for mobile phone recorder or said standard female receptacle for stereo sound recording and music sharing is equipped on said control box alone.

4. The acoustic apparatus of claim 2, wherein it is allowable to equip both said female receptacle for mobile phone recorder and said standard female receptacle for stereo sound recording and music sharing on said control box together.

5. The acoustic apparatus of claim 1, wherein either said female receptacle for mobile phone recorder or said standard female receptacle for stereo sound recording and music sharing is connected to said standard female receptacle for dual sound output alone.

6. The acoustic apparatus of claim 1, wherein said female receptacle for mobile phone recorder and said female receptacle for stereo sound recording and music sharing equipped on said standard female receptacle for dual sound output can be removed to said control box.
